(19) United States
(12) Patent Application Publication
(10) Pub. No.: US 2004/0169405 A1
(43) Pub. Date: Sep. 2, 2004

(54) Seat for aircraft and land vehicles, particularly for light aircraft

(76) Inventor: Derek Stinnes, Trollenhagen (DE)

Correspondence Address: GOODWIN PROCTER L.L.P, 103 EISENHOWER PARKWAY, ROSELAND, NJ, 07068, US

(21) Appl. No.: 09/771,368

(22) Filed: Jan. 26, 2001

(30) Foreign Application Priority Data
Feb. 1, 2000 (DE) 200 01 748.9

(51) Int. Cl. B60N 2/42

(52) U.S. Cl. 297/216.1

(57) ABSTRACT

A seat for aircraft and land vehicles that is light, adjustable and dimensionally stable and has good damping properties. The seat comprises a seat shell having at least one guide integrated into the seat surface for holding an aid frame. A base frame comprising compression and tension members is attached to the base of the vehicle and has an additional lateral member which is located forward and at the front. The aid frame is formed from two longitudinal members and at least one lateral member, where the front ends of the longitudinal members are rotatably attached to the additional lateral member of the base frame.

The innovation relates to a seat, particularly for sport aircraft and light aircraft, which meets the present safety requirements (crash properties). It can also be used in small, light land vehicles, such as go-carts.

A large number of seat constructions are known for different demands and types of vehicles. However, the basic requirements with respect to the safety properties are the same for all aircraft. This is the case particularly for the crash properties during the horizontal and vertical impact of an aircraft. Great strength and dimensional stability of the whole seat are required in order to absorb the large forces without much deformation, so that the seated person is protected. The mounting of damping elements in the seat frame for attenuating the effect of the impact on the person due to the strong negative acceleration is known. Elements, which are deformed reversibly or irreversibly, are known (DE) OS 1755006, GM 8526591, U.S. Pat. No. 4,861,103, etc.). Different arrangements result, depending on the construction of the seat frame and of the configuration of the elements. Integrating them directly into vertical supports is expensive, since additional guides are required for the damping motion during the crash.

According to the German Offenlegungsschrift 4221974, it is furthermore known that shock-absorbing elements may be disposed diagonally in a frame of the seat. A scissors parallelogram, which makes the necessary movement possible, is obtained by means of four pivot bearings at the connections of the frame parts of a frame side. This solution offers much space for then damping element. The large overall height and the cost of the pivot bearings are a disadvantage.

A conventional configuration of the seat, which meets the requirements, leads to relatively heavy constructions, which have a negative effect on the total weight, particularly in the case of small aircraft. For this reason and because of the limited spatial relationships, only simple seat shells, which are fastened directly to the fuselage, are customary for light aircraft. However, the safety properties of these seats are completely inadequate and do not meet present requirements. A safety license can therefore be obtained only in the form of a single license. In order to reduce the weight, the proposal is made in the German Offenlegungsschrift 3811939 to employ a sandwich construction for seat parts. For this purpose, covering layers are glued to both sides of a sandwich panel. A high strength and a low weight are achieved with this known technology, which is, however, work intensive. However, only individual parts (seat, crossbeam, back rest) are manufactured pursuant to the invention and connected together by appropriate elements, which represents an additional expense.

It is therefore an object of the invention to configure a seat, which is intended particularly for light aircraft, is low in weight, requires little space and has a high strength and dimensional stability and good damping properties and furthermore permits the actual seat to be adjusted.

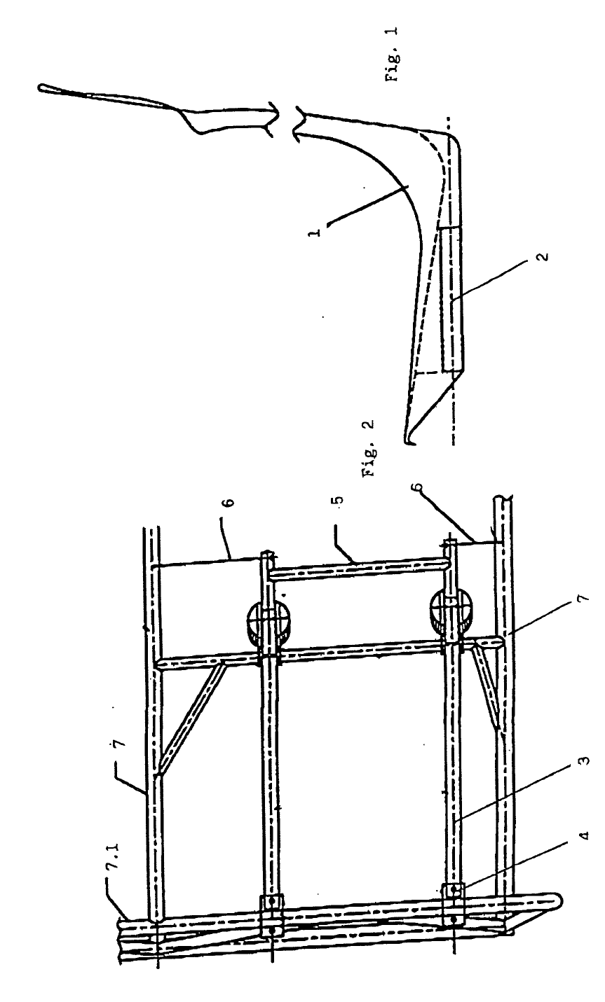

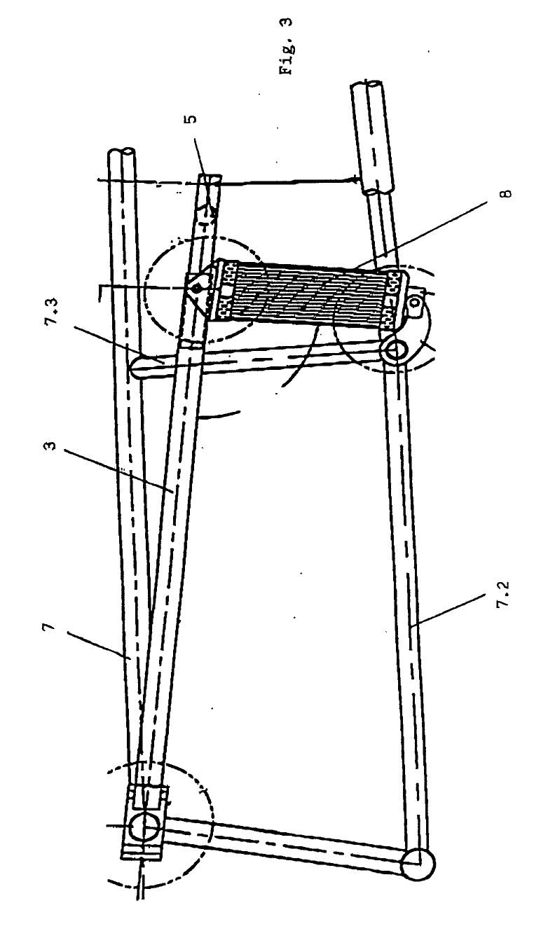

This objective is accomplished innovatively in accordance with the distinguishing features of the claims. By means of the new combination of seat shell with a rotatably mounted auxiliary frame, and mainframe connected over damping elements, this seat is very light, is dimensionally stable and has a high degree of damping. Damping paths and guidance of the damping element or elements are made possible simultaneously by the rotatable mounting of auxiliary frame on the front, upper basic frame. The seat shell can be shifted horizontally on the auxiliary frame and is deviated vertically by horizontally shifting the receptacle for the upper bearing of the damping element. At the same time, this arrangement also saves space, which is important for small passenger cells. Further advantageous developments of the invention are listed in the in the dependent claims. In the following, the innovation is explained by means of an example. FIG. 1 shows the seat shell in a side view, FIG. 2 shows the basic frame arrangement and the auxiliary frame arrangement in plan view and FIG. 3 shows the same in front view. The seat shell 1 with the backrest and seating surface, consists of one piece and is manufactured from a multi-layered laminate of fiberglass mats and rovings. A guide tube 2 is laminated in on each side below the seat surface. With that, the seat shell is guided on an auxiliary frame 3. The sides of the backrest and seat surface are curved and reinforced by additional appropriate narrow laminate layers and sandwich layers. In the example the auxiliary frame 3 and the basic frame 7 consists of welded pipes. The basic frame 7 is composed of a lower 7.2 and upper 7 longitudinal carriers and transverse carriers, which are connected by supports 7.3. The basic frame is fastened to the bottom of the vehicle. The auxiliary frame 3 consists of two longitudinal carriers, which are connected by a transverse carrier 5. The longitudinal carriers of the auxiliary frame 3 are disposed between the longitudinal carriers 7.2 of the basic frame and, in the front, are mounted rotatable at the upper, front transverse carrier 7.1 of the basic frame 7.

The front ends of the two longitudinal carrier of the auxiliary frame 3 are fastened in crossing-over clamps 4, which rotatably embrace the front, upper, transverse carrier 7.1 of the basic frame 7. Into each of the rear ends of the two longitudinal carrier of the auxiliary frame 3, a pipe is pushed. These pipes are connected by a transverse carrier 5 and form a displaceable receptacle for the upper mounting of the damping element 8. The lower mountings of the damping elements 8 are constructed rotatably at the basic frame 7, so that swiveling of the seat shell becomes possible by shifting the upper receptacle. The damping elements consist of a cylindrical honeycomb grid of light metal, the ends of which are enclosed in receptacles, which at the same time form head bearings. For stabilization, the rear ends of the two longitudinal carrier of the auxiliary frame 3 are connected by a rope 6 with the rear, lower ends of the two longitudinal carriers 7.2 of the basic frame 7.

1. A seat for aircraft and land vehicles, especially for light aircraft, consisting of a seat shell, frame and damping devices, wherein the seat consists of a seat shell (1) with at least one guide (2) integrated in the seat surface for accommodating an auxiliary frame (3), a basic frame (7), which consists of longitudinal and transverse carriers and can be fixed to the bottom of the vehicle and has an additional transverse carrier (7.1), disposed higher at the front, an auxiliary frame (3), which consists of two longitudinal carriers and is connected by at least one carrier (6) and the front ends of the longitudinal carrier of which are rotatable mounted at the additional transverse carrier (7.1) of the basic frame (7), which is disposed higher at the front, and at least one damping element (8), which is disposed approximately perpendicularly between the rear part of the basic frame (7) and the rear auxiliary frame (3).

2. The seat of claim 1, wherein the backrest and the seat surface are constructed in one piece, in the shape of a shell, from a multi-layer laminate and a guide pipe (2) is laminated below the seat surface on each side.

3. The seat of claim 1, wherein the sides of the backrest and seat surface are curved and reinforced by additional, appropriately narrow laminate layers.

4. The seat of claim 1, wherein the basic frame (7) consists of lower and upper longitudinal and transverse carriers, which are welded together and to supports (7.3) and can be fastened to the bottom of the vehicle.

5. The seat of claim 1, wherein the front ends of the two longitudinal carriers of the auxiliary frame (3) are mounted between the upper longitudinal carriers of the basic frame (7), at the upper, front transverse carrier (7.1) of this basic frame.

6. The seat of claim 1, wherein the front ends of the two longitudinal carriers of the auxiliary frame (3) are rotatable connected by means of crossing-over clamps (4) with the front, upper, transverse carriers (7.1) of the basic frame (7).

7. The seat of claims 1 to 6, wherein a displaceable receptacle for each of the upper mountings of the damping element (8) is disposed in the rear ends of the two longitudinal carriers of the auxiliary frame (3).

8. The seat of claim 1, wherein the lower mounting of the damping elements (8) is constructed rotatably at the basic frame (7), so that, by shifting the upper receptacle, an adjustment of the slope seat shell (1) becomes possible.

9. The seat of claims 1 to 8, wherein the damping element (8) consists of a cylindrical honeycomb grid of light metal, the ends of which are held by bearings in cylindrical receptacles 10. The seat of claim 1, wherein the rear ends of the two longitudinal carriers of the auxiliary frame (3) are each connected by a rope (6) with the rear, lower ends of the two longitudinal carriers of the basic frame (7) 11. The seat of claim 1, wherein, for securing the horizontal position of the seat shell (1), a double hoop is fixed vertically pivotably at the front seat bottom region and can be locked with a pin in the upper longitudinal carrier of the basic frame (7).
